(19) United States
(12) Patent Application Publication
(10) Pub. No.: US 2006/0147600 A1
(43) Pub. Date: Jul. 6, 2006

(54) 'Maca Blast' energy drink

(76) Inventors: Rosa Gonzales, Rockville, MD (US); Victor Pereyra, Rockville, MD (US)

Correspondence Address: ROSA GONZALES, 4606 BAYNE CT., ROCKVILLE, MD, 20853, US

(21) Appl. No.: 11/088,838

(22) Filed: Mar. 25, 2005

(30) Foreign Application Priority Data
Jan. 3, 2005 (PE) 000016-2005/OIN

(51) Int. Cl. A23L 2/00

(52) U.S. Cl. 426/590

(57) ABSTRACT

The present invention is a new high quality natural energy drink created in base of extract of Maca and Camu-Camu; other ingredients are natural extract of Guarana, caffeine, glucose, fructose and water, drink is carbonated. Procedure to prepare beverage is presented too. The composition is the result of the investigation to find the process of extraction of a beverage of Maca of high energetic power and pleasant flavor, offering consumers corporal and mental enhancement in natural and optimum form, containing recommended amounts of Maca and Camu-Camu of optimal consumption. Maca and Camu Camu, present in this energy beverage complements their qualities for a better operation of the immune system. The Camu Camu, already known in the entire world by presenting a largest quantity of vitamin C naturally in a fruit, permits the stimulation and strengthens the immune system. Maca is very internationally renowned for its extraordinary nutritional properties.

This document presented by Kelas International S.A.C. corresponds to the Application for a Registered Patent of a natural energy drink which under the brand name of “Maca Blast Energy Drink” is an energy drink based on Maca, Camu-Camu and other components with high nutritional value and energy for the consumer, and delicious flavor that we need to present as creation of this company claiming the invention, preparation and contents of the energy drink.

### I. DESCRIPTION—MACA BLAST ENERGY DRINK

1.1 Title of the Invention

MACA BLAST ENERGY DRINK, natural energy drink based on of Maca and Camu-Camu.

1.2 Technical Sector

This invention refers to the elaboration of an energy drink based on of Maca extract and Camu-Camu.

1.3 Description of the State of Art

So far, until today a natural energy drink in bases of Maca and Camu-Camu is not prepared, that is of pleasant flavor and at the same time exploits the tremendous potential energetic of Maca, the known difficulties known are the strong and characteristic flavor and smell of Maca, that until now has place this product in the field of nutritional products, while the main difficulty to consumers is the ingestion of Maca by its bitter taste.

### 1.4 SUMMARY OF THE INVENTION

Energy drinks concept is quite attractive, its international development is extraordinary, the concept of—beverage and energy together in a bottle is very appealing, if a person has more energy is going to improve his performance at work, this concept is very desirable for every one and especially for active people. Maca with its properties of being an exceptional food in reason of its nutritional properties is called to play a very important role in the field of energy drinks. The invention consist in the preparation of an energy drink composed of extract of Maca flour, natural Camu-Camu extract, glucose, fructose, natural extract of Guarana and citric acid, such composition is the result of the investigation to find the appropriate formulation for a drink of Maca with high nutritional value and pleasant taste and flavor, that offers to the consumer enhanced mental and corporal performance optimally and naturally, Maca with its nutritional and nutraceutic characteristics presents such qualities. It has taken into consideration too: corporal reposition of lost electrolytes caused by body's sweating, necessary to preserve metabolic balance in of the body, when exercise or work stress and hardship has occur, Maca and Camu-Camu, present in this energy drink complement its properties for a better functioning of immunologic system, acting synergistically in the detoxification of the organism and the elimination of free radicals. Camu Camu, recognized in the world for the highest natural concentration of Vitamin C, permits the stimulation and fortification of the immunologic system; being a powerful antioxidant is complemented by the citric acid, the natural Guarana extract permits the stimuli of cerebral functions and metabolism.

Maca acting in the cellular micro circulation activates neuronal functioning revitalizing cerebral functions, with its contents of estrogen, alkaloids, glucosilinates, flavonoids and phytohormones acts at the glandular level that produces the hormones, permitting a better production and regulation (in men and women) with the benefits of:
Stimulate naturally of the hypothalamus and the hypophysys and these in turn to the endocrine glands (thyroids, pancreas, suprarenal, ovaries and testicles) to return them to healthy functioning, produce natural quantity of hormones to keep homeostasis of human body. (Chacon, 1999, 2000; Obregon, 1998; León, 1964, 1986; Tafur, 2002).
Natural treatment of premenstrual syndrome and its regulation. Favoring natural reproductive capacity. The estrogens, phytohormones, glucosalinates, and alkaloids in Maca improve the sexual Libido. (Pulgar, 1978; Obregon, 1998; Garcia and Chirinos, 1999; Jones 1980; Gonzales, Corboba and others, 2002).
Natural treatment of menopause syndrome (Pulgar, 1978; Obregon, 1998).
Natural treatment of the cholesterol. (Lobaton).

High content of calcium favors in the youth natural calcification and the consolidation of the development of the skeletal bones helps to the treatment of patients with fractures and injuries in the skeletal system, rachitis and osteomalacia, prevents the osteoporosis in women (favored by the phytohormones of the Maca).

For its high content of iron and magnesium it stimulates the hematopoiesis (formation and growth of the red corpuscles) and the treatment of anemia.

For its content of zinc, vitamins C and E, manganese and copper is considered a powerful antioxidant, such quality is reinforced through the Camu-Camu content, avoids the cellular precocious aging and also presents distress properties.

For its contents of phosphorus it takes part in the generation of the corporal cellular energy, in the formation and ATP cycle and consequent energy flow to the metabolism of the persons. It helps to the structural functions that affect to the skeleton and the soft tissues, and regulating the functions of the neuromuscular transmission of the chemical and electrical stimuli.

Maca possess almost every one of the main amino acids (seven of eight), and two or three of main fatty acids. Between amino acids of Maca is the glycine that acts as neurotransmitter, the arginine that improves memory, the histidine that improves sexual response, isoleucine and leucine that augments muscular vigor, forms and repair muscular tissue, the glutamic, acid that has great importance in the functioning of the central nervous system and that acts as stimulant of the immunologic system, the aspartic acid that is so important in the detoxification of the liver and adequate functioning, this acid combines with other amino acids conforms molecules that are capable to absorb toxins of the sanguine torrent. The cystine and cysteine take part in the detoxification, acting principally as antagonist of the free radicals, acting in this mode synergistically with the Camu-Camu in the protection of the human body and its metabolism. [Rea, 1994; Dini & others, 1994; Quiros & others, 1996].

There are two polyunsaturated fatty acids (PUFAs) that cannot be made in the body are linoleic acid and alpha-linolenic acid. They must be provided by diet and are known as essential fatty acids. Within the body both can be converted to other PUFAs such as arachidonic acid, or eicosapentaenoic acid (EPA) and docosahexaenoic acid (DHA).

In the body PUFAs are important for maintaining the membranes of all cells; for making prostaglandins which regulate many body processes which include inflammation and blood clotting. Another requirement for fat in the diet is to enable the fat-soluble vitamins A, D, E and K to be absorbed from food; and for regulating body cholesterol metabolism.

Maca has fatty acids: the monounsaturated oleic acid, and polyunsaturated linoleic and alpha-linoleic, oleic acid is important to maintain low cholesterol, like the olive oil, its contents of polyunsaturated fatty acids are similar to the soja. (Interlabor Belp, Switzerland, 2001)

Maca at an appropriate concentration according the effort to carry out avoids the mental and physical fatigue.

Maca presents two indispensable elements for the development and to maintain a so much, adequate bony system in males and women without limit of age, such elements are the calcium and phosphor, both been present in the bones, and Maca stimulates the absorption of these, permits the obtaining of hard and healthy bones.

The copper, in the levels present in the Maca, permits a better operation of the enzymes, indispensable for the metabolism of the human being.

The beneficial properties of the Maca are remarkable, is the food of the millennium, its effects are: anti aging, antidepressant, increment of the libido, reinforcement the immune system, improvement of the emotional balance and the resistance to mental and physical stress, increase of the memory, improvement of the sexual vitality and of the fertility. By its content of vitamins B, C, E and minerals: zinc, manganese and the copper already mentioned acts as antioxidant, avoids the premature cell aging.

The Camu-Camu with very high content of vitamin C, is the richest source of the planet that be known in vitamin C, and reaches up to 2,700 mg by 100 grams of pulp, this is equivalent from 40 to 60 times more than that of the pulp of the orange, and has 10 times more iron, 3 times more niacine and two times more rivoflavine. Besides it contains beta carotene, calcium, phosphor, proteins, thiamine, is rich in bioflavonoids. The Camu-Camu is anti-inflammatory, acts as astringent tonic, boost the corporal energy (is stamina), anti stress and improves the athletic performance. It acts similarly to the orange juice with its healthy characteristics for the human body, like the promotion of the cohesion of the proteins, increase of the muscular performance, promotion of the absorption of the iron, prevention of the scurvy, it is considered that has natural properties for the treatment and the prevention of cancer, and is a powerful defense against the herpes, besides serves to treat illnesses of allergic nature as the asthma and the bronchitis, prevents the arthritis and the rheumatism and other illnesses related. The camu-camu reduces the effects of many substances producing allergies and prevents the risks of intoxication, anemia, etc., protecting liver from diseases, renal alterations and of the nervous system and possibly cardiovascular illnesses (anti sclerotic) (Duke, 1997; Beckstrom-Sternberg, Ethnobotany and Phytochemical Databases, U.S. Dept. of Agriculture, Agricultural Research Service, USDA; Zapata, 1993; Franco, Shibamoto, 2000; Justi, 2000).

The present Invention Patent application has as its purpose to obtain an integrated combination of the extract of the flour of Maca, Camu-Camu, extract of Guarana, the glucose and the fructose, by means of which we obtain an energy beverage of quick absorption, pleasant to the palate and that lends all the benefits already indicated of its essential components. Likewise it is obtained through the extraction and filtration of the extract of Maca, the process to sweeten the beverage and its mixture with the natural extract of Guarana renders a very pleasant beverage, of adequate consistency, that is taken very well chilled.

Preparation

In the preparation of this energy beverage we have considered that the dose recommended of flour of Maca oscillates among a teaspoon (approximately from 2.5 to 3.5 grams) to a spoonful for day (15 grams), with the premise to obtain a beverage with the following characteristics:
The beverage should not present the bitter and strong flavor that is characteristic in the Maca,
The beverage should be transparent with a definite color, like caramel, characteristic color of the energy beverages,
The beverage should not be precipitated in the bottom of its deposit of content,
should have a pleasant flavor to palate,
should comply with the present energy values in the better beverages inside this area,
The beverage should be preserved within a time frame of a year or more, in base to its natural preservers.

With the concepts previously established and after numerous prior experiences, that have included the study of the methods that at present are utilized to prepare the beverages, nectars, extracts of Maca and other similar products, comes the process define here described

Initially the extract of Maca is prepared, mixing atomized flour of Maca, apt and list for the human consumption, in a liter of high-quality water are added from 40 to 50 grams of Maca flour, to this mixture citrus acid is added up to a concentration between 2 to 3% in order to obtain the best extraction of its amino acids, sterols and other components. The mixture is dissolved and is carried to a stove where the mixture is heated gradually until it reaches to a temperature of 85° C. to 90° C. (185° F. to 194° F.), the mixture is maintained to said temperature for five minutes, the mixture is chilled quickly carrying it to temperature in the environment and then is filtered carefully, the result is a liquid that is extract of Maca, presenting its characteristic smell, is transparent and of color bronze intense.

After it obtained the extract of Maca, proceeds to the preparation of the energy beverage, diluting it in water to obtain a concentration of the 25 to 45%, and it continues with the process that is detailed subsequently.

The camu-camu is extracted delicately from selected fruits, the process that is described has been developed to preserve the nutritious value of this fruit, since separates carefully the pulp of its cortex and seeds, to extract the juice the pulp is filtered, maintaining all the process at low temperature in order to not degraded the content of ascorbic acid, vitamins B1, B2 and Niacin. The camu-camu with its natural vitamins favors the formation of the collagen, stimulates the natural defenses of the human body and intervenes in the absorption of the iron originating in the food of vegetable origin; the camu-camu is recognized like an essential element to strengthen beverages for sportsmen of nutraceutic kind.

In their applications as antioxidant augments the defenses of the human body, acts like an immune-stimulating agent and is also antibacterial, aid to avoid the fatigue and is important in the formation of muscles, tendons and ligaments, it plays an essential role for the absorption of the iron, prevents the anemia of the sportsman, acts synergistically with the Maca to permit that the efforts carried out for the daily work, exercise and another type of stress that the consumers can have, allowing the elimination of free radicals generated by the exercise and intense work, by means of its therapeutic action, it also present a preventive action against cell aggression due to the oxidation by radicals. The ascorbic acid protects the brain, nervous system and woven muscular from free radicals and converts to the Oxidized Vitamin E to its non oxidized form. The camu-camu is regarded as the number 1 natural treatment for the asthma, cunning-sclerosis, cataracts, colds, edema, gingivitis, glaucoma, hepatitis, infertility, migraines, Osseo arthritis, and is a natural analgesic too.

The camu-camu, high competition sports and oxidative damage: the role of the antioxidant nutrients. At the beginning of the eighties it was shown by means of electrons paramagnetic resonance, the formation of free radicals of oxygen in muscle during the intense physical exercise. This fact, promoted a series of works above all of the group of Packer in California, that tried to clarify if the radicals free they could be responsible for the muscular damage that is observed after the intense physical exercise.

Prevention of the effects of the radicals free formed during the physical exercise, by means of the administration of antioxidants. In many laboratories, it has been shown that the possibility exists to minimize the effects of free radicals of oxygen by means of the administration of antioxidants such as: beta carotene, vitamin C, vitamin E, glutathione, N-acetilcisteina, etc. It is not strange, therefore, that have tested the effect of the administration of antioxidants to try to alleviate, al less in part, the harmful effects of the intense physical exercise that can be attributed the radicals free. Evidence exists currently, that the administration of antioxidants has beneficial effects against the harmful effects of the intense physical exercise. It has been shown that the administration of vitamin C, of vitamin E or of glutathione, protects against the harmful effect of free radicals in the so much physical exercise in rats as in human beings.

The natural extract of Guarana is the source chosen to provide the impulse of necessary initial energy, its high content of caffeine, the highest one in the world, provides the initial content of energy of this beverage, which is among 15 to 20 mg by each 100 milliliters of energy beverage. The natural extract of Guarana possesses various activity ingredients due to its multiple components. It is cardio tonic (stimulates the activity of the cardiac muscle), has astringent properties and anti inflaming. It is considered a good one general reconditioning, ideal for every one that may suffer some physical and intellectual decline. It stimulates the vital functions of the human body, the virility and the power, the reflexes, the memory and the intellectual activity.

The sugars that form part of the energy beverage provide the necessary energy of this beverage, with a combination of glucose that is present in a percentage of the 3 al 5% and of fructose whose contribution is among 5 to a 7%, in order to providing the sources of consumable and necessary energy in planned schedule inside the energy beverage.

In the table that follows down, is shown the range of contribution of the different components.

The process of preparation of our energy beverage is very meticulous; the ingredients are selected and mixed carefully, the particular contribution of the different components is essential to permit the benefits of their contribution. The addition of the dioxide carbonic permits the stabilization of the beverage that is complemented with the sorbate of potassium in a proportion of the 1 al 3%.

The energy beverage comprises extract of Maca in a contribution that is between 2.5 to 4.5 grams by dose of energy beverage of 250 milliliters, 6 to 13 milliliters of extract of Camu Camu, from 15 to 21 grams of fructose, glucose among 7.5 to 12.5 grams, among 0.75 to 1.5 milliliters of natural extract of Guarana, citrus acid among 3 al 5%. It is important to indicate that the energy beverage presents properties of acidity controlled, the PH between the 3 and the 4% and the contribution of the sugars is controlled to obtain adequate energy content among 8 to 12 degrees Brix. Besides the energy drink having a delicious flavor.

2.1. Nutraceutic energy drink in base to flour of Maca which contribute with 2.5 to 4.5 grams, extract of camu-camu among 6 to 13 milliliters, glucose with a contribution among 7.5 to 12.5, fructose among 15 to 21 grams, citrus acid in a solution of the 2 al 4%, natural extract of Guarana among 0.75 to 1.5%, for each unit of 250 milliliters of beverage, characterized by its pleasant flavor. The beverage bases on its exceptional components permits a fast replenishment of the energy loss, aid to overcome the pressures and hardship of the daily life, the stress and the modern life and adds with very important elements for the health and the personal well being.

2.2. Procedure for the preparation of the energy beverage here presented, in base to the flour of Maca and the extract of Camu-Camu, as well as the preparation with the addition of the other components. It is characterized by the preparation of an extract of Maca, in base to the composition already indicated in the number 1, where the atomized flour of Maca is mixed with water of quality and citrus acid, is carried to a stove where is heated gradually until reaches to a temperature between 85 degrees to 90° C., being maintained among this temperature for five minutes, the mixture is chilled quickly to temperature environment, the solution is them filtered carefully, avoiding to drag solid residues, the resultant liquid is transparent and brilliant, of a coppery color. The extract of Maca with the extract of Camu-Camu is mixed the which is extracted carefully of the pulp of the fruit maintaining it always to low temperature, to such mixture is added natural extract of Guarana, glucose and fructose, resulting in a beverage of very pleasant flavor, which is carbonated with dioxide carbonic, then a preserve is added, making it ready for the human consumption.
